(19) United States
(12) Patent Application Publication
(10) Pub. No.: US 2010/0043049 A1
(43) Pub. Date: Feb. 18, 2010

(54) IDENTITY AND POLICY ENABLED COLLABORATION

(76) Inventors: Stephen R. Carter, Spanish Fork, UT (US); Lloyd Leon Burch, Payson, UT (US); Carolyn B. McClain, Springville, UT (US)

Correspondence Address: SCHWEGMAN, LUNDBERG & WOESSNER/NOVELL, PO BOX 2938, MINNEAPOLIS, MN, 55402, US

(21) Appl. No.: 12/192,688

(22) Filed: Aug. 15, 2008

(51) Int. Cl. H04L 9/32

(52) U.S. Cl. 726/1; 726/21; 726/4

(57) ABSTRACT

Techniques for identity and policy enabled collaboration are provided. Access to assets of an enterprise is governed by identity relationships. A policy defines security restrictions between collaborating network resources based on identities assigned to the network resources. During collaboration, the security restrictions are enforced.

### BACKGROUND

The future of computing is becoming more compelling every day. Processors are now commonly provided with multiple processing cores (multi-core) and are capable of operating on substantial data workloads. Moreover, networks are getting faster thus allowing access to non-local storage and access to services that heretofore were unknown. These two trends are allowing more collaboration between virtual teams in a way that, if not controlled, will put enterprises at substantial security risks.

That is, the ability to access enterprise assets 24 hours a day, 7 days a week, and for 365 days a year from virtually any device and from virtually any location is becoming a reality. With this reality, security issues become more problematic for an enterprise. With all assets conceivably capable of being accessed from any location and at any time, the enterprise needs more robust security that at the same time can provide fine-grain security to account for every acceptable and conceivable situation that may occur.

Conventional techniques do not provide for robust and yet at the same time fine-grain and customizable security techniques.

Accordingly, improved techniques for collaboration security are desirable.

### SUMMARY

In various embodiments, techniques for identity and policy enabled collaboration are presented. More specifically, and in an embodiment, a method for identity and policy enabled collaboration is provided. A request is received from a principal for accessing a resource. Next, a principal identity and a policy are acquired for the request. The policy includes security restrictions for the principal identity when accessing the resource. Finally, the security restrictions are enforced when the principal accesses the resource.

### BRIEF DESCRIPTION OF THE DRAWINGS

FIG. 1 is a diagram of a method for identity and policy enabled collaboration, according to an example embodiment.

FIG. 2 is a diagram of another method for identity and policy enabled collaboration, according to an example embodiment.

FIG. 3 is a diagram of an identity and policy-enabled collaboration system, according to an example embodiment.

FIG. 4 is a diagram of another identity and policy-enabled collaboration system, according to an example embodiment.

### DETAILED DESCRIPTION

A “resource” includes a service, system, device, directory, data store, user, groups of users, combinations of these things, etc. A “principal” is a specific type of resource, such as an automated service or user that acquires an identity. A designation as to what is a resource and what is a principal can change depending upon the context of any given network transaction. Thus, if one resource attempts to access another resource, the actor of the transaction may be viewed as a principal.

An “identity” is something that is formulated from a one or more identifiers, secrets, and/or attributes that provide a statement of roles and/or permissions that the identity has in relation to resources. An “identifier” is information, which may be private and permits an identity to be formed, and some portions of an identifier may be public information, such as a user identifier, name, etc. Some examples of identifiers include social security number (SSN), user identifier and password pair, account number, retina scan, fingerprint, face scan, etc. As more and more identifiers are accumulated, a confidence in a particular identity grows stronger and stronger. In an embodiment, the identifier is a signature or a pair of signatures. For example, the signature of an identity service that vouches for a crafted identity, the signature of a principal associated with the crafted identity, or the signature of both the identity service and the principal.

“Authentication” is the process of validating the association of identifiers and secrets according to a policy, which is specific to the context in which the resulting identity is to be used. Thus, when identifiers are validated within a context specific to how an identity is to be used, it is authentication.

A “crafted identity” is an identity that may permit a principal's true identity to remain anonymous from the resource it seeks to access. With a crafted identity, an identity vault (e.g., one or more repositories holding secrets and identifiers) is opened to create the crafted identity and authenticate the principal to which it is associated, and then the identity vault is closed. Thereafter, the crafted identity can be validated by a resource, and acted upon without ever re-referencing the identity vault.

Example creation, maintenance, and use of crafted identities are discussed in U.S. patent Ser. No. 11/225,993 (“Crafted Identities”); commonly assigned to Novell, Inc. of Provo, Utah and the disclosure of which is incorporated by reference herein.

In some embodiments, an identity service is used. Examples of an identity service can be found in: U.S. patent Ser. Nos. 10/765,523 (“Techniques for Dynamically Establishing and Managing Authentication and Trust Relationships”), 10/767,884 (“Techniques for Establishing and Managing a Distributed Credential Store”), and 10/770,677 (“Techniques for Dynamically Establishing and Managing Trust Relationships”). These applications are also commonly assigned to Novell, Inc. of Provo, Utah and the disclosures of which are incorporated by reference herein.

Various embodiments of this invention can be implemented in existing network architectures. For example, in some embodiments, the techniques presented herein are implemented in whole or in part in the Novell® network, identity management, directory services, and proxy server products, distributed by Novell®, Inc., of Provo, Utah.

Of course, the embodiments of the invention can be implemented in a variety of architectural platforms, operating and server systems, or applications. Any particular architectural layout or implementation presented herein is provided for purposes of illustration and comprehension only and is not intended to limit aspects of the invention.

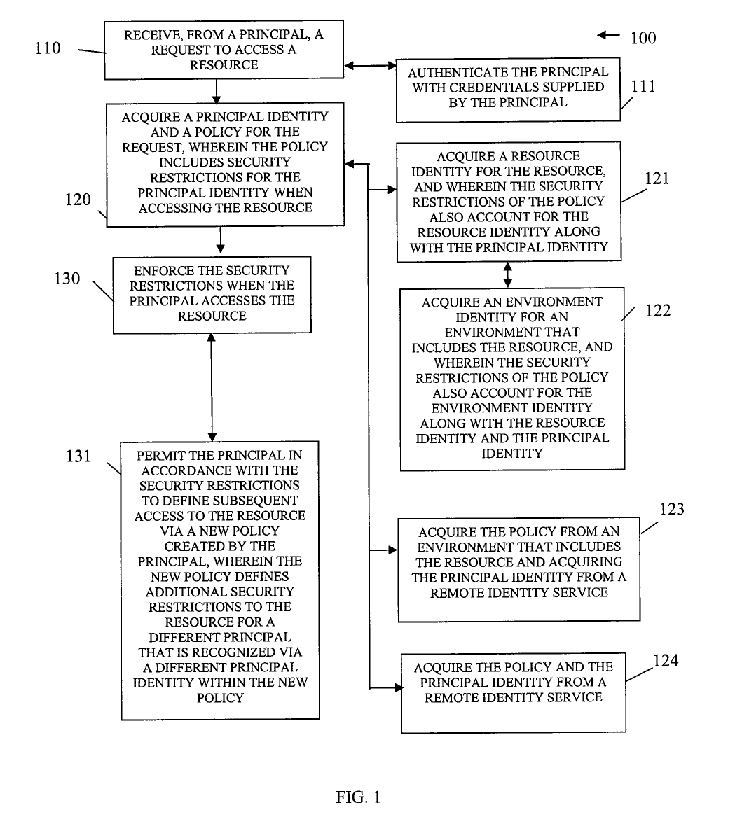

It is within this context that embodiments of the invention are now discussed with reference to the FIGS. 1-4.

FIG. 1 is a diagram of a method 100 for identity and policy enabled collaboration, according to an example embodiment. The method 100 (hereinafter “security collaboration service”) is implemented in a machine-accessible and readable medium. The security collaboration service is also operational over a network and the network can be wired, wireless, or a combination of wired and wireless.

The security collaboration service enforces security restrictions between collaborating resources as discussed in greater detail herein and below.

At 110, the security collaboration service receives a request to access a resource from a principal. The principal is also a type of resource. The request is for access or for collaboration between the principal and the resource.

The security collaboration service can be viewed as a proxy or other type of service that intercepts the requests made by the principal and processes those requests in the manners discussed herein and below. The proxy can be a forward proxy, a transparent proxy, or even a reverse proxy acting on behalf of the resource that the principal desires collaboration with.

According to an embodiment, at 111, the security collaboration service authenticates the principal with credentials supplied by the principal. That is, the principal is authenticated in response to the request if the principal is not already authenticated to the network. The credentials can be in any form, such as digital signatures, certificates, biometrics, passwords, assertions, or various combinations of these things. In some cases, the security collaboration service enlists the services of an identity manager or identity service to authenticate the principal to the network.

At 120, the security collaboration service acquires a principal identity and a policy for the request. The policy includes security restrictions for the principal identity when accessing the resource. So, the principal authenticates to or is assigned to a principal identity and the policy associates or links the security restrictions to the principal identity and the resource. Thus, the policy is identity enabled based on the identity of the principal and/or the identity of the resource. Any level of granular security restrictions can be defined in the policy.

As an example, at 121, the security collaboration service also acquires a resource identity for the resource. The security restrictions of the policy account for the resource identity and the principal identity. It is the combination of identities that defines a particular collaboration situation and that links the security restrictions to that situation. This provides fine-grain security at the identity level and is defined via a configured policy.

In still another situation, at 122, the security collaboration service acquires an environment identity for an environment that includes the resource. The security restrictions of the policy account for the combination of identities that include the environment identity, the resource identity, and the principal identity. The environment can be viewed as a processing context; this can include physical and virtual machines having different Operating System (OS) environments and different available resources. So, in one sense the environment may be viewed as a container for the resource. A single resource can have multiple different and disparate containers (processing contexts or environments), each container having its own policy with its own identity-defined security restrictions. This allows for a tremendous amount of customization and fine grain security.

In an embodiment, at 123, the security collaboration service acquires the policy from an environment that includes the resource at the same time the principal identity is acquired from a remote identity service. In other words, the policy can be defined and carried within a local processing context or environment associated with the resource that is being accessed while the assignment of identity is obtained via a remote and external identity service over the network.

In another situation, at 124, the security collaboration service acquires both the policy and the principal identity from a remote identity service that is external and remote from an environment that includes the resource. So, the policy can be local or external to the environment that includes the resource, which is being requested. In some cases, the policy may exist in a partial global form in an external environment that is acquired via the remote identity service and at the same time the policy may exist in a local form within a local environment that includes the resource. The policy can be hierarchical and can be logically assembled in a dynamic and real time fashion when processing the requests from a variety of locations and utilizing a variety of services/resources.

At 130, the security collaboration service enforces the security restrictions when the principal accesses the resource. Dynamic and real time enforcement is achieved via the security collaboration service; this is done by evaluating the policy that is identity-based. The policy can also be assembled from a variety of local and remote sources and can be hierarchical in nature.

In an embodiment, at 131, the security collaboration service permits the principal, in accordance with the security restrictions, to define subsequent access to the resource via a new policy that the principal creates. In such a situation, the original policy allows the principal to define and create new access scenarios for other principals of the network. The new policy defines additional security restrictions for accessing the resource with respect to a different principal that is recognized by a different principal identity within the new policy.

Consider the following example situation that demonstrates how the security collaboration service processes in the given situation. Suppose an initial environment includes a LINUX® OS on a Virtual Machine (VM) and that environment (E) includes a spreadsheet file (X) that a user (principal U) wants to access. Initially, a policy (P) associated with accessing X is defined by an owner of X or an administrator of E. The P includes an identity for U and an identity for X and perhaps even an identity for E and/or VM, etc. P is defined to use the identities which are associated with a security restriction that permits U to open and use X once and does not permit U to forward X or even print X. During operation, U attempts to access X, the security collaboration service intercepts or is notified of this access attempt and immediately resolves the identity for U (may already be resolved or may need to be resolved via an identity service that assists the security collaboration service). Once the identity of U is known, the security collaboration service acquires the P either locally from E or globally via the identity service (or in some cases from both sources). Once P is acquired, the security collaboration service enforces the security restriction against U, such that U can only use X once and cannot forward or print X. This is but one scenario and a variety of others can and will exist. All such scenarios that utilize the processing of the security collaboration service and that tie identity and policy based access collaboration together are intended to fall within the generous scope of this disclosure.

It is also noted that the identities can be crafted identities or even semantic identities. The policy can account for these types of identities and can define the security restrictions for the resource accordingly.

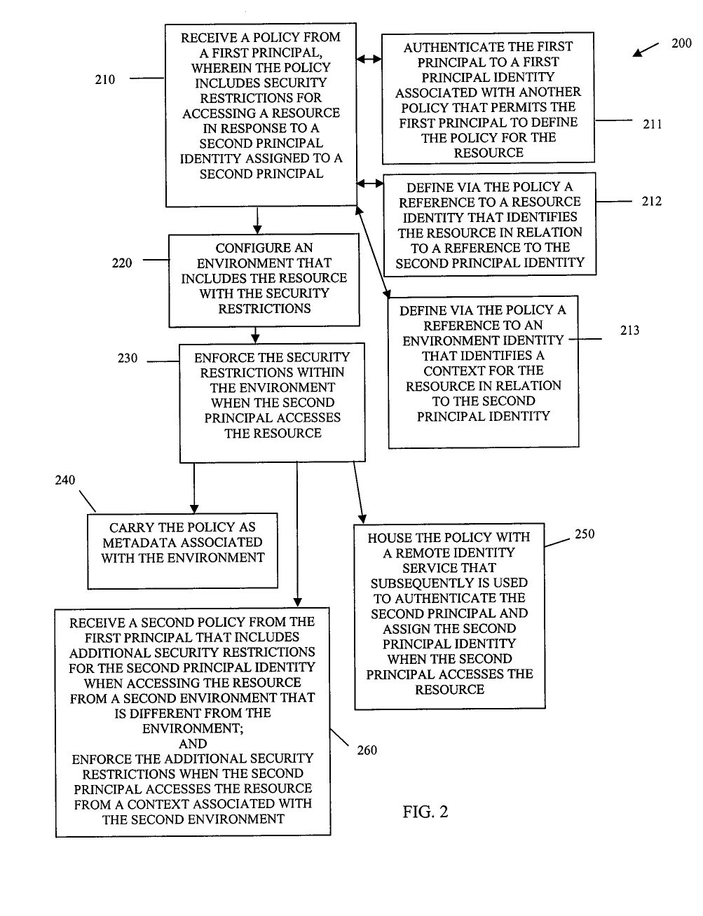

FIG. 2 is a diagram of another method 200 for identity and policy enabled collaboration, according to an example embodiment. The method 200 (hereinafter “security configuration service”) is implemented in a machine-accessible and readable medium. The security configuration service is operational over a network. The network may be wired, wireless, or a combination of wired and wireless. The security configuration service represents initial processing used, in an embodiment, to configure the security collaboration service represented by the method 100 of the FIG. 1.

At 210, the security configuration service receives a policy from a first principal. The first principal is an owner of a resource or someone with proper security permissions to define access to a resource, such as an administrator, etc. The policy includes security restrictions for accessing a resource in response to a second principal identity assigned to a second principal. So, the policy ties the security restrictions to the second principal identity and perhaps one or more additional conditions or events.

In an embodiment, at 211, the security configuration service authenticates the first principal to a first principal identity. The first principal identity is associated with another policy that permits the first principal to define the policy for the resource. This was stated another way above. Another policy provides the mechanism or permission for the first principal to define the policy in terms of the second principal identity.

In an embodiment, at 212, the security configuration service defines, via the policy, a reference to a resource identity that identifies the resource in relation to a reference to the second principal identity. That is, the security restrictions defined in the policy are tied to the combination of the second principal identity and the resource identity via references to the identities that the policy uses. So, the policy is identity driven based on the identity of resources (requesting principals, target assets/devices, etc.).

In another situation, at 213, the security configuration service defines, via the policy, a reference to an environment identity that identifies a particular context for the resource in relation to a reference to the second principal identity. Here, the policy also accounts for a processing context (environment) that the resource lives and processes within. The tripartite relationship between a reference to the resource identity (target resource being requested), a reference to the environment (processing context of the resource), and reference to the second principal (requesting principal or resource) is associated with the security restrictions provided within the defined policy.

At 220, the security configuration service configures an environment that includes the resource with the security restrictions. That is, the security configuration service configures the policy for enforcement within the environment of the resource, such that whenever the resource is accessed the policy is identified and enforced within the environment.

At 230, the security configuration service enforces the security restrictions within the environment when the second principal accesses the resource. The policy is basically dynamically acquired and enforced in real time each time access attempts are made against the resource within the environment.

According to an embodiment, at 240, the security configuration service carries the policy as metadata associated with the environment (processing context of the resource).

In another case, at 250, the security configuration service houses the policy with a remote identity service. The remote identity service is subsequently used to authenticate the second principal and assign the second principal identity when the second principal accesses the resource.

Thus, the policy can be local within the local processing context of the resource being requested and/or the policy can be globally managed or enforced and acquired remotely from a remote identity service.

In a particular situation, at 260, the security configuration service receives a second policy from the first principal that includes additional security restrictions for the second principal identity when accessing the resource from a second environment that is different from the environment. So, the resource may have a one identity (non unique) and yet have different processing contexts (multiple instances). Each processing context can be used to establish uniqueness for a particular instance of the resource. Alternatively, each instance of the resource can have its own unique identity. The security configuration service enforces the additional security restrictions when the second principal accesses the resource from a context associated with the second environment. Thus, a single resource having multiple instances that process in multiple different environments (processing contexts) can be associated with different policy that the security configuration service enforces on an environment specific basis.

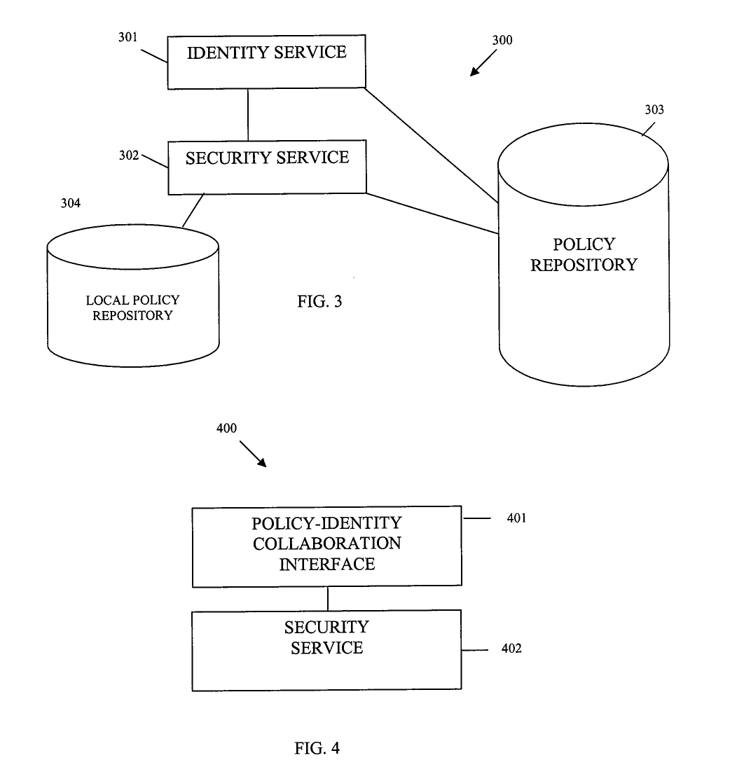

FIG. 3 is a diagram of an identity and policy-enabled collaboration system 300, according to an example embodiment. The identity and policy-enabled collaboration system 300 is implemented in a machine-accessible and computer-readable storage medium and is operational over a network. The network may be wired, wireless, or a combination of wired and wireless. In an embodiment, the identity and policy-enabled collaboration system 300 implements among other things the security collaboration service represented by the method 100 of FIG. 1.

The identity and policy-enabled collaboration system 300 includes an identity service 301 and a security service 302. In some embodiments, the identity and policy-enabled collaboration system 300 may also include a policy repository 303 and one or more local repositories 304. Each of these will now be discussed in turn.

The identity service 301 is implemented in a computer-readable storage medium and is to process on computers or processor-enabled devices connected to the network. Example identity services 301 that may be modified to achieve the teachings presented herein were discussed and incorporated by reference above.

The identity service 301 authenticates a principal to a particular principal identity. It is noted that a single principal can have multiple different identities and depending upon the credentials supplied by a principal and the context, the identity service 301 authenticates the principal to a particular principal identity that is specific to a particular request being made by the principal. The principal identity is associated with a principal's request to access a given resource of a network.

In an embodiment, the identity service 301 can consult one or more additional identity services 301 of the network to assist it in authenticating and resolving the principal identity associated with the request to access the resource.

The identity service 301 acts as a third-party service that assists the security service 302 in resolving and authenticating identities and in some cases resolving and acquiring policy to enforce security restrictions.

The security service 302 is implemented in a computer-readable storage medium and is to process on computers or processor-enabled devices connected to the network. Example processing associated with the security service 302 was provided in detail above with reference to the methods 100 and 200 of the FIGS. 1 and 2, respectively.

The security service 302 obtains policy that is specific to the principal identity assigned by the identity service 301 and specific to the resource that the principal is requesting access to or collaboration with. The policy includes security restrictions that are enforced by the security service 302 against the principal during access to the resource. The policy can reside in multiple network locations and/or in a variety of locations throughout the network.

In an embodiment, the identity and policy-enabled collaboration system 300 also includes a policy repository 303. The policy repository 303 is implemented in a computer-readable storage medium and is accessed over the network by the identity service 301. The policy repository 303 is used for housing, managing, and distributing the policy. The policy may be indexed within the policy repository 303 in response to identities assigned to the principal and the resource. Of course it is understood that any indexing scheme can be used without departing from the teachings presented herein.

According to an embodiment, the policy is obtained by the security service 302 as metadata that is associated with the resource. That is, the resource can carry the metadata that includes the policy in some cases.

In another situation, the policy is obtained by the security service 302 as metadata associated with an environment that includes the resource. So, the processing context of the resource can globally include metadata having the policy for defining the identity-based security restrictions, which further define access to the resource.

In another case, the identity and policy-enabled collaboration system 300 includes a local policy repository 304. The local policy repository 304 is implemented in a computer-readable storage medium and is accessed by the security service 302 to obtain the policy from an environment that includes the resource. The local policy repository 304 is within the environment of the resource and is therefore considered to be local to the resource and the environment.

It is noted that in some cases the policy may be represented in a global policy repository 303 and at the same time a local policy repository 304. Here, the policy can have global overrides in the global policy repository while retaining local control in the local policy repository 304. So, multiple policy repositories 303 and 304 can be used and a hierarchy of policies can be implemented with some embodiments. This provides greater customization and fine-grain control while maintaining global or coarse-grain control. In some cases, specific local policy can override more generic global policy. So, overrides can occur in either direction (global to local or local to global).

FIG. 4 is a diagram of another identity and policy-enabled collaboration system 400, according to an example embodiment. The identity and policy-enabled collaboration system 400 is implemented in a machine-accessible and computer-readable storage medium and is to be processed by machines (computers or processor-enabled devices) over a network. The network may be wired, wireless, or a combination of wired and wireless. In an embodiment, the identity and policy-enabled collaboration system 400 performs, among other things, the processing associated with the method 100 of the FIG. 1 and performs, among other things, the processing associated with the method 200 of the FIG. 2.

The identity and policy-enabled collaboration system 400 includes policy-identity collaboration interface 401 and a security service 402. Each of these will now be discussed in turn.

The policy-identity collaboration interface 401 is implemented in a computer-readable storage medium and is to process on computers or processor-enabled devices connected to the network. Example aspects of the policy-identity collaboration interface 401 were presented above with reference to the method 200 of the FIG. 2.

The policy-identity collaboration interface 401 interacts with a principal for purposes of defining a policy. The policy includes security restrictions for collaboration scenarios that can occur between two or more resources of the network based on identities that are assigned to those two or more resources. Again, it is noted that any particular resource can have different identities that vary depending upon the context.

The policy defines security restrictions in response to: a reference to a requesting resource identity assigned to a requesting resource, a reference to a target resource identity assigned to a target identity, and a reference to an environment identity assigned to an environment that includes the target resource.

In some cases, the requesting resource identity is a crafted identity that is supplied by an identity service to the requesting resource for accessing the target resource.

In an embodiment, the policy-identity collaboration interface 401 stores the policy in a policy repository that is accessible from within a specific environment that houses a target resource. The policy repository is accessed by the security service 402 from within the environment.

In another case, the policy-identity collaboration interface 401 stores the policy in a policy repository that is accessible over the network to an identity service that also collaborates with the security service 402 and is in a trusted and authenticated relationship with the security service 402.

The security service 402 is implemented in a computer-readable storage medium and is to process on computers or processor-enabled devices connected to the network. Example aspects of the security service 402 were presented in detail above with reference to the method 100 of the FIG. 1, the method 200 of the FIG. 2, and the system 300 of the FIG. 3.

The security service 402 configures the policy and enforces the policy when the two or more resources collaborate with one another over the network. That is, access between resources are defined via identity-based policy restrictions that are defined via the policy-identity collaboration interface 401 and enforced via security service 402 in a dynamic and real time fashion.

It is now appreciated how a more robust and yet at the same time fine-grained security technique can be established for collaborating network resources. Policy defines the identity-based security restrictions and the policy is easily customized to the needs of a particular resource, a group or resources, and/or an enterprise as a whole.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A machine-implemented method, comprising:
receiving, from a principal, a request to access a resource;
acquiring a principal identity and a policy for the request, wherein the policy includes security restrictions for the principal identity when accessing the resource; and
enforcing the security restrictions when the principal accesses the resource.

2. The method of claim 1, wherein receiving further includes authenticating the principal with credentials supplied by the principal.

3. The method of claim 1, wherein acquiring further includes acquiring a resource identity for the resource, and wherein the security restrictions of the policy also account for the resource identity along with the principal identity.

4. The method of claim 3, wherein acquiring further includes acquiring an environment identity for an environment that includes the resource, and wherein the security restrictions of the policy also account for the environment identity along with the resource identity and the principal identity.

5. The method of claim 1, wherein acquiring further includes acquiring the policy from an environment that includes the resource and acquiring the principal identity from a remote identity service.

6. The method of claim 1, wherein acquiring further includes acquiring the policy and the principal identity from a remote identity service.

7. The method of claim 1, wherein enforcing further includes permitting the principal in accordance with the security restrictions to define subsequent access to the resource via a new policy created by the principal, wherein the new policy defines additional security restrictions to the resource for a different principal that is recognized via a different principal identity within the new policy.

8. A machine-implemented method, comprising:
receiving a policy from a first principal, wherein the policy includes security restrictions for accessing a resource in response to a second principal identity assigned to a second principal;
configuring an environment that includes the resource with the security restrictions; and
enforcing the security restrictions within the environment when the second principal accesses the resource.

9. The method of claim 8, wherein receiving further includes authenticating the first principal to a first principal identity associated with another policy that permits the first principal to define the policy for the resource.

10. The method of claim 8, wherein receiving further includes defining via the policy a reference to a resource identity that identifies the resource in relation to a reference to the second principal identity.

11. The method of claim 10, wherein receiving further includes defining via the policy a reference to an environment identity that identifies a context for the resource in relation to the second principal identity.

12. The method of claim 8 further comprising, carrying the policy as metadata associated with the environment.

13. The method of claim 8 further comprising, housing the policy with a remote identity service that subsequently is used to authenticate the second principal and assign the second principal identity when the second principal accesses the resource.

14. The method of claim 8 further comprising:
receiving a second policy from the first principal that includes additional security restrictions for the second principal identity when accessing the resource from a second environment that is different from the environment; and
enforcing the additional security restrictions when the second principal accesses the resource from a context associated with the second environment.

15. A machine-implemented system, comprising:
an identity service implemented in a computer-readable storage medium and to process on a network; and
a security service implemented in a computer-readable storage medium and to process on the network;
wherein the identity service is to authenticate a principal to a principal identity when the principal requests access to a resource, and wherein the security service is to obtain a policy that is specific to the principal identity and the resource, the policy includes security restrictions that are enforced by the security service against the principal during access to the resource.

16. The system of claim 15 further comprising, a policy repository implemented in a computer-readable storage medium and accessed over the network by the identity service to supply the policy to the security service.

17. The system of claim 15, wherein the policy is obtained by the security service from metadata associated with the resource.

18. The system of claim 15, wherein the policy is obtained by the security service from metadata associated with an environment that includes the resource.

19. The system of claim 15 further comprising, a local policy repository implemented in a computer-readable storage medium and accessed by the security service to obtain the policy from an environment that includes the resource, wherein the local policy repository is within the environment of the resource and is therefore local to the resource and the environment.

20. The system of claim 15, wherein the identity service consults a second identity service to assist in resolving the principal identity on behalf of the security service.

21. A machine-implemented system comprising:
a policy-identity collaboration interface implemented in a computer-readable storage medium and to process on a network; and
a security service implemented in a computer-readable storage medium and to process on the network;
wherein the policy-identity collaboration interface is to interact with a principal to define a policy, the policy includes security restrictions for a collaborations that can occur between two or more resources based on identities assigned to those two or more resources, and wherein the security service configures the policy and enforces the policy when the two or more resources collaborate with one another on the network.

22. The system of claim 21, wherein the policy-identity collaboration interface stores the policy in a policy repository that is accessible over the network to an identity service that collaborates with the security service.

23. The system of claim 21, wherein the policy-identity collaboration interface stores the policy in a policy repository that is accessible from within a specific environment that houses a target resource, the policy repository accessed by the security service from within the environment.

24. The system of claim 21, wherein the policy defines the security restrictions in response to a requesting resource identity assigned to a requesting resource, a target resource identity assigned to a target resource, and an environment identity assigned to an environment that includes the target resource.

25. The system of claim 24, wherein the requesting resource identity is a crafted identity provided by an identity service to the requesting resource for accessing the target resource.
